(19) United States
(12) Patent Application Publication
(10) Pub. No.: US 2007/0064924 A1
(43) Pub. Date: Mar. 22, 2007

(54) Method of configuring interface device and protection device in digital communication system, and the resultant system

(75) Inventors: Chun-Sheng Chang, Hsinchu (TW); Tung-Cheng Chiang, Hsinchu (TW)

Correspondence Address: BACON & THOMAS, PLLC, 625 SLATERS LANE, FOURTH FLOOR, ALEXANDRIA, VA, 22314, US

(73) Assignee: Loop Telecommunication International, Inc., Hsinchu (TW)

(21) Appl. No.: 11/219,721

(22) Filed: Sep. 7, 2005

(51) Int. Cl. H04M 3/00; H04M 1/00; H04M 5/00; H04M 9/00

(52) U.S. Cl. 379/412; 379/331

(57) ABSTRACT

A method for configuring an interface device and a protection device in a digital communication system. The interface device has a first port for communicating with other devices, the first port being in a high-impedance state when the interface device fails. The protection device has a second port for replacing the communication of the interface device when the interface device fails, the second port being in a high-impedance state when the protection device is not in the replacing state. The primary winding of a first transformer is in series connection with the first port, and the primary winding of a second transformer is in series connection with the second port. The secondary winding of the first transformer and the secondary winding of the second transformer are connected in parallel. The resultant configuration makes the system simplified, compact, economic and easy for maintenance.

### BACKGROUND OF THE INVENTION

1. Field of the Invention

The present invention relates to digital communication systems, more particularly to the configuration of an interface device and a protection device in the digital communication system.

2. Description of the Prior Art

Conventional digital communication systems have developed to form various standards such as T1, T3, E1, E3, DS3 (Digital Signal 3), SDH9 (Synchronous Digital Hierarchy), SONET (Synchronous Optical NETwork), etc.

In the systems, communications are carried out through various interface devices, such as transmitters, receivers, transceivers, etc. In order to protect the communications from interruption by the failure of the interface devices, protection or backup devices with the same communication functions are typically adopted to replace the communications in the interface devices in time once the interface devices fail.

Typically, the interface devices and the protection devices are configured to form two protection modes, i.e. 1+1 and N+1 protection modes, where the 1+1 protection mode uses one protection device for one interface device, while the N+1 protection mode uses one protection device for N (more than one) interface devices.

FIG. 1 shows a schematic diagram of a conventional configuration of an interface circuit and a protection circuit in a digital communication system, forming a 1+1 protection mode.

An interface device 102 placed on a module (a board, or card) 101 and a protection device 104 placed on a module (a board, or card) 103 are configured with relay contacts 106, 107, 108 and 109 as well as a transformer 110. The primary winding of the transformer 110 is connected to the relay contacts 106 and 107, and the secondary winding of the transformer 110 is connected to other devices. The transformer 110 is for impedance match with other devices. Such relay contacts are properly controlled to make the interface device 102 through a port thereon communicate with other interface device(s) when the interface device 102 is in normal state, and make the protection device 104 replace the communication in the interface device 102 when the interface device 102 fails.

The relay devices for such communications are generally bulky. Thus, the relay contacts 106-109 and the transformer 110 are placed on a separate module (a board, or card) 105. And the relay devices require additional control signals and consume a large amount of power. The above disadvantages will be exacerbated when the number of the interface device in the system increases. Further, the relay contacts have slow switching times, which would result in the loss of data and even the loss of frame in the communications. Although the relay devices can be replaced by analog switches for better performances, such analog switches still occupy somewhat space and consume somewhat power.

An improvement has been developed, as shown in FIG. 2, which adopts an interface device 202 having a port which is in a high-impedance state when the interface device 202 fails to communicate with other devices through the port. The interface device 202 is placed on a module (a board, or card) 201. A protection device 204 placed on a module (a board, or card) 203 has a port which is in a high-impedance state when the protection device 204 does not replace the communication in the interface device 202. The high-impedance state can be formed by a tri-state circuit.

With the interface device 202 and the protection device 204, the ports thereon for communication can be connected in parallel and then connected to the primary winding of a transformer 207 to obtain the same failure protection function but without the use of the relay devices or analog switches. Hence, the configuration of FIG. 2 is advantageous over that of FIG. 1.

However, for maintenance, the connection of the ports of the interface device 202 and the protection device 204 as well as the primary winding of the transformer 207 must be placed in a separate module (a board, or card) 205, and the transformer 207 is also placed in a separate module (a board, or card) 206. Such arrangement result in the complication and higher cost of the system.

Therefore, there is a need for a configuration of the interface device and the protection device in the digital communication system, which has a simplified arrangement and lower cost while without the disadvantages caused by the use of the relay devices or analog switches.

### SUMMARY OF TH INVENTION

A general object of the present invention is to provide a configuration of an interface device and a protection device in a digital communication system, thereby making the system have a simplified arrangement and lower cost while without the disadvantages caused by the use of the relay devices or analog switches.

According to one aspect, the present invention provides a method of configuring an interface device and a protection device in a digital communication system, the interface device having a first port for communicating with other devices, the first port being in a high-impedance state when the interface device fails, the protection device having a second port for replacing the communication of the interface device when the interface device fails, the second port being in a high-impedance state when the protection device is not in the replacing state, the method comprising the steps of providing a first transformer having a primary winding and a secondary winding, the primary winding of the first transformer being in series configuration with the first port of the interface device; providing a second transformer having a primary winding and a secondary winding, the primary winding of the second transformer being in series configuration with the second port of the protection device; and connecting the secondary winding of the first transformer in parallel with the secondary winding of the second transformer.

According to another aspect, the present invention provides a digital communication system comprising an interface device and a protection device, the interface device having a first port for communicating with other devices, the first port being in a high-impedance state when the interface device fails, the protection device having a second port for replacing the communication of the interface device when the interface device fails, the second port being in a high-impedance state when the protection device is not in the replacing state, the system further comprising a first transformer having a primary winding and a secondary winding, the primary winding of the first transformer being in series connection with the first port of the interface device; and a second transformer having a primary winding and a secondary winding, the primary winding of the second transformer being in series connection with the second port of the protection device, where the secondary winding of the first transformer is in parallel connection with the secondary winding of the second transformer.

### BRIEF DESCRIPTION OF THE DRAWINGS

In order to more clearly delineate the above and other features and advantages of the present invention, a further description with reference to the accompanying drawings is given below, wherein:

FIG. 1 shows a schematic diagram of a conventional configuration of an interface circuit and a protection circuit in a digital communication system;

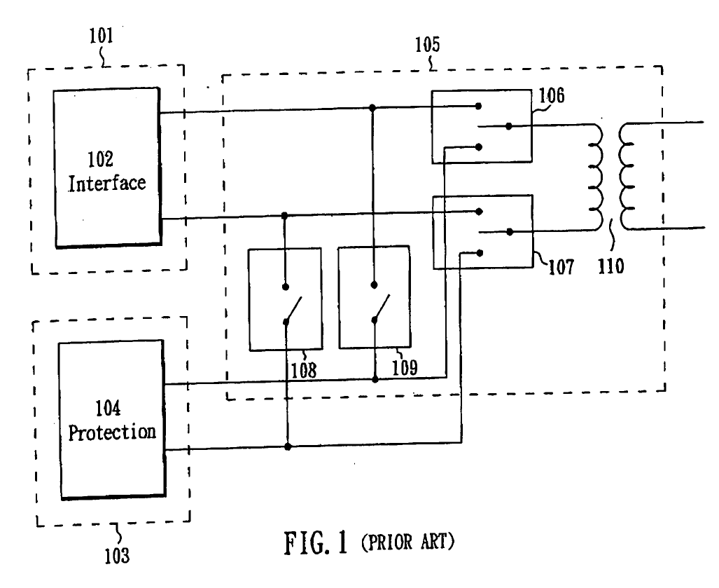

FIG. 2 shows a schematic diagram of another conventional configuration of an interface circuit and a protection circuit in a digital communication system; and

FIG. 3 shows a schematic diagram of a configuration of an interface circuit and a protection circuit in a digital communication system according to the present invention.

### DETAILED DESCRIPTION OF THE PREFERRED EMBODIMENTS

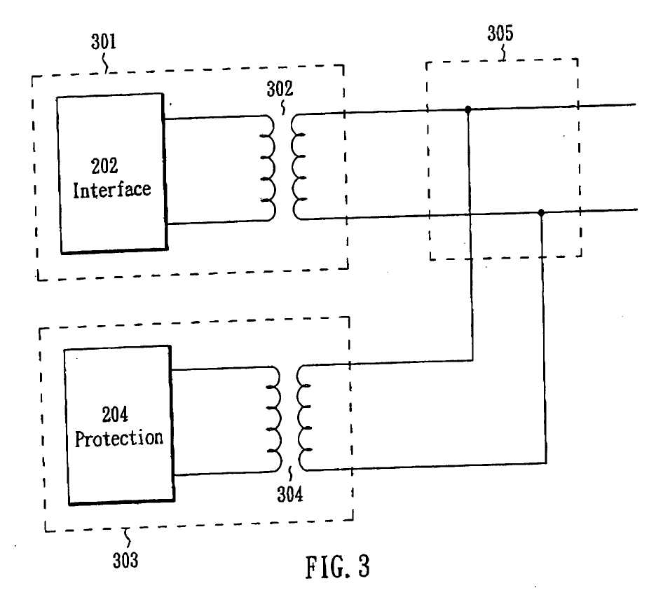

According to one preferred embodiment of the present invention, as schematically shown in FIG. 3, the system is configured to include the interface device 202, the protection device 204, a transformer 302 and a transformer 304.

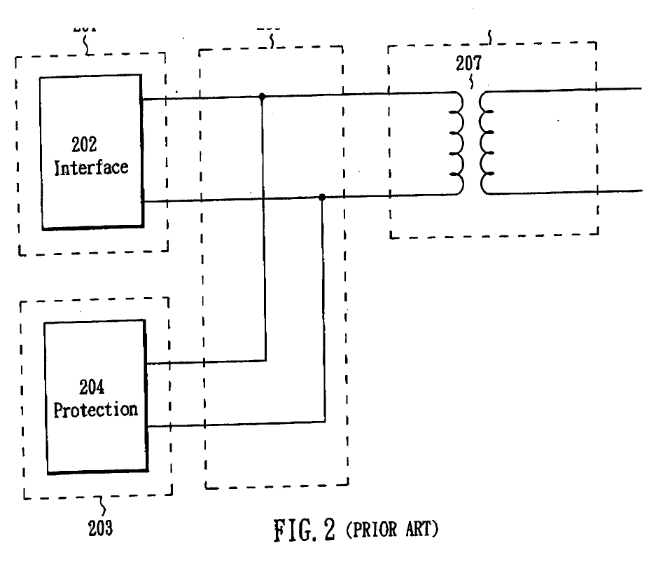

The interface device 202, as given in FIG. 2, has a port which is in a high-impedance state when the interface device 202 fails to communicate with other devices through the port. The port of the interface device 202 is configured to be in series connection with the primary winding of the transformer 302. The secondary winding of the transformer 302 connects to other device(s) for impedance match therewith. The transformer 302 can be placed closer to the interface device 202, and preferably, the transformer 302 and the interface device 202 can be integrated and placed on a module (a board, or card) 301.

The protection device 204, as given in FIG. 2, has a port which is in a high-impedance state when the protection device 204 does not replace the communication in the interface device 202. The port of the protection device 204 is configured to be in series connection with the primary winding of the transformer 304. The secondary winding of the protection device 204 is configured to be in parallel connection with the secondary winding of the transformer 302. The transformer 304 can be placed closer to the interface device 204, and preferably, the transformer 304 and the interface device 204 can be integrated and placed on a module (a board, or card) 303.

The high-impedance state of the interface device 202 and the protection device 204 can be formed by a tri-state circuit, for example, or other proper means.

For maintenance, the connection of the secondary winding of the transformer 302 and the secondary winding of the transformer 304 is placed on a separate module (a board, or card) 305.

In normal operation, the interface device 202 communicates with other device(s) through the transformer 302. The protection device 204 is controlled not to function to replace the communication of the interface device 202, and the port in series connection with the primary winding of the transformer 304 is in the high-impedance state as mentioned above. Thus, although connected in parallel with the secondary winding of the transformer 302, the secondary winding of the transformer 304 will not affect the normal communication.

If the interface device 202 fails to communicate, the port in series connection with the primary winding of the transformer 302 will be switched to the high-impedance state as mentioned above. The protection device 204 will be controlled to immediately replace the communication of the interface device 202 through the transformer 304. Since the port in series connection with the primary winding of the transformer 302 is in the high-impedance state, the secondary winding of the transformer 302 will not affect the communication occurring at the secondary winding of the transformer 304.

Compared to FIG. 2 which needs two separate modules 205 and 206, the present configuration needs only one separate module 305, and the transformer 302 and the transformer 304 can be located close to or integrated with the interface device 202 and the protection device 204, respectively, thereby making the system simplified, compact and economic. In addition, once the module 301 including the interface device 202 and the transformer 302, or the module 303 including the protection device 204 and the transformer 304 fails, the module 301 or the module 303 can be easily replaced without interrupting the communication.

Other details for the above preferred embodiment should be obvious to those skilled in the art, particularly to those skilled in the art of digital communication systems.

Although the present invention has been described in detail with reference to the above-illustrated particular embodiments, it is not intended that such particular embodiments be considered as limitations upon the scope of the present invention except in-so-far as set forth in the following claims.

What is claimed is:

1. A method of configuring an interface device and a protection device in a digital communication system, the interface device having a first port for communicating with other devices, the first port being in a high-impedance state when the interface device fails, the protection device having a second port for replacing the communication of the interface device when the interface device fails, the second port being in a high-impedance state when the protection device is not in the replacing state, the method comprising the steps of:
providing a first transformer having a primary winding and a secondary winding, the primary winding of the first transformer being in series configuration with the first port of the interface device;
providing a second transformer having a primary winding and a secondary winding, the primary winding of the second transformer being in series configuration with the second port of the protection device; and
connecting the secondary winding of the first transformer in parallel with the secondary winding of the second transformer.

2. The method of claim 1, wherein the first transformer is placed closer to the interface device than to the parallel configuration.

3. The method of claim 1, wherein the second transformer is placed closer to the protection device than to the parallel configuration.

4. The method of claim 2, wherein the first transformer and the interface device are placed in a module.

5. The method of claim 3, wherein the second transformer and the protection device are placed in a module.

6. The method of claim 1, wherein the parallel connection is formed in a module.

7. The method of claim 1, wherein the interface device is a transmitter and the protection device is a transmitter.

8. The method of claim 1, wherein the interface device is a receiver and the protection device is a receiver.

9. The method of claim 1, wherein the interface device is a transceiver and the protection device is a transceiver.

10. The method of claim 1, wherein the high-impedance state is formed by a tri-state circuit.

11. The method of claim 1, wherein the digital communication system is for T1, T3, E1, E3, DS3, or fiber optical communication.

12. A digital communication system comprising an interface device and a protection device, the interface device having a first port for communicating with other devices, the first port being in a high-impedance state when the interface device fails, the protection device having a second port for replacing the communication of the interface device when the interface device fails, the second port being in a high-impedance state when the protection device is not in the replacing state, the system further comprising:
a first transformer having a primary winding and a secondary winding, the primary winding of the first transformer being in series connection with the first port of the interface device; and
a second transformer having a primary winding and a secondary winding, the primary winding of the second transformer being in series connection with the second port of the protection device,
where the secondary winding of the first transformer is in parallel connection with the secondary winding of the second transformer.

13. The system of claim 12, wherein the first transformer is placed closer to the interface device than to the parallel configuration.

14. The system of claim 12, wherein the second transformer is placed closer to the protection device than to the parallel configuration.

15. The system of claim 13, wherein the first transformer and the interface device are placed in a module.

16. The system of claim 14, wherein the second transformer and the protection device are placed in a module.

17. The system of claim 12, wherein the parallel connection is formed in a module.

18. The system of claim 12, wherein the interface device is a transmitter and the protection device is a transmitter.

19. The system of claim 12, wherein the interface device is a receiver and the protection device is a receiver.

20. The system of claim 12, wherein the interface device is a transceiver and the protection device is a transceiver.

21. The system of claim 12, wherein the high-impedance state is formed by a tri-state circuit.

22. The system of claim 12, wherein the digital communication system is for T1, T3, E1, E3, DS3, or fiber optical communication.
